(19) United States
(12) Patent Application Publication
(10) Pub. No.: US 2009/0006532 A1
(43) Pub. Date: Jan. 1, 2009

(54) DYNAMIC PHISHING PROTECTION IN INSTANT MESSAGING

(75) Inventors: Richard Sinn, Milpitas, CA (US); Miles Libbey, Mountain View, CA (US); Linlong Jiang, Sunnyvale, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/770,490

(22) Filed: Jun. 28, 2007

(51) Int. Cl. G06F 15/173

(52) U.S. Cl. 709/203; 709/225

(57) ABSTRACT

Method, apparatus, and systems are directed to phishing detection and prevention in Instant Messaging (IM) environments. A variety of sources provide phishing data to a client phishing engine (CAE). The CAE may receive data from various applications local to the client device, from sources external to the client device, user input, and data from a plurality of other client devices. The CAE may employ the data to block access to a site and/or provide a warning message. At least some of the phishing data is provided to a centralized anti-phishing server (CAS) from a plurality of client devices. The CAS then attempts to use the received phishing data to search for the originator of the phishing site, and prevent future messages associated with the site. CAS will provide information about the detected phishing sites to a filtering application, such that the phishing site may be appropriately blocked.

### BACKGROUND

The present invention relates generally to computing security, and more particularly but not exclusively to providing a phishing detection mechanism employing collective client knowledge for further detecting a phishing source.

A major type of internet fraud, today, is known as phishing. Phishing typically involves the practice of obtaining confidential information through the manipulation of legitimate users. Typically, the confidential information is a user's password, credit card details, social security number, or other sensitive user information. Phishing may be carried out by masquerading as a trustworthy person, website, or business. In one approach, a message may be sent to an unsuspecting user. The message may include a link or other mechanism that links to an illegitimate source. In another approach, a webpage that may appear to be legitimate is provided to the user. However, the webpage (or message) is designed to trick the user into providing their confidential information. Such webpages (or messages) may relate to account log-in sites, credit card entry sites, or the like. Once the unsuspecting user enters their information, the phisher may be able to obtain the sensitive information and use it to create fake accounts in a victim's name, ruin the victim's credit, make purchases under the victim's name, sell the information to others, perform acts under the victim's identity, or even prevent the victim from accessing their own money and/or accounts.

Unfortunately, such phishing activities have crossed over from messages within emails, or the like, to links provided within instant messages (IM). Instant messages with phishing links may be obtained from a known source, or even from an unknown source, often making it difficult to determine whether a link within an IM message is safe. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Descriptions, which is to be read in association with the accompanying drawings, wherein:

FIG. 1 shows a functional block diagram illustrating an environment for practicing the invention;

FIG. 2 shows one embodiment of a client device that may be employed;

FIG. 3 shows one embodiment of a network device that may be employed to provide an anti-phishing service;

FIG. 4 illustrates a flow diagram generally showing one embodiment for a client process of managing a client side detection of an instant messaging (IM) phishing attempt; and

FIG. 5 illustrates a flow diagram generally showing one embodiment for a centralized server process of providing IM phishing detection, identification, and prevention, in accordance with the invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The terms “sensitive,” and “confidential” information refer to any information that a user would prefer not to be widely distributed. Such information may be something that the user knows, such as their social security number, a password, encryption key number, credit card number, financial information, driver's license number, insurance number, mother's maiden name, or the like. The information may also represent data about the user, including, for example, their age, birth date, medical information, or the like.

Briefly, the present invention is directed towards a method, apparatus, and system for providing phishing detection and prevention for Instant Messaging (IM) environments. A variety of sources provide phishing data to a client phishing data collection engine (CAE) that is configured to reside locally within a client device. The CAE may receive in real time, data obtained from various applications local to the client device, including a browser application, anti-virus application, personal firewalls, spam filters, operating system components, or the like. The CAE may also receive phishing data from sources external to the client device, such as from third party providers of phishing information. In one embodiment, the CAE may also provide an interface to the user of the client device to provide input to identify a phishing link. Moreover, the CAE may also receive phishing information that has been collected from a plurality of other client devices. The collected phishing information may include, however, more than merely an identifier of a phishing site. The collected information may also include other information such as when the phishing event was detected, how it was detected (e.g., what application), how often the phishing event was detected, where the phishing site might have been detected (e.g., to determine whether it is a local event, regional event, or the like), when the phishing site was detected (to determine whether a time related pattern of receiving information about the site may exist), as well as information indicating whether the phishing site's link appears in different groupings of network addresses, whether the phishing site's link appear in other communication mechanisms (e.g., such as email, or the like), as well as a variety of other data.

When a text messaging client, such as an IM client application, receives a message that includes a link to a network site, the CAE employs the phishing data to determine whether to block access to the site and/or provide the user a warning message indicating that the link is to a potential phishing site. In one embodiment, the user might be provided access to the suspected phishing site, for example, if a low number of other client devices have identified the site and the site is not already a known phishing site. While a low number is an arbitrary value, in one embodiment, it may be set to around 2-5 other client devices. However, other values may also be used. Thus, if, in one embodiment, the number of other client devices identifying the suspected phishing site exceeds this value, the CAE may select to block access to the site, delete the message associated with the link to the site, or the like.

At least some of the phishing data collected by the CAE is provided to a centralized anti-phishing server (CAS). The CAS may also receive phishing data from a plurality of other client devices. The CAS may then analyze the received phishing data to determine where the phishing site may be located, including a network address, and, if possible, a geographical location, site owner, or the like. The CAS may also assess how many client devices have detected the phishing site, whether the phishing site is included in messages to a particular geographic region, group of client devices, messages that include the phishing site are sent at a particular time of day, whether the phishing site has been identified as being sent through other communication mechanisms, and the like. The CAS may then attempt to search for the phishing site, based in part on the analysis. If it is determined that the phishing site can be removed from a server site, the CAS will initiate such actions to do so, including contacting a server authority, law enforcement agencies, or the like. Moreover, the CAS will provide information about the detected phishing sites to a filtering application, such that the phishing site may be appropriately blocked. By employing the present invention, phishing sites may be rapidly detected and blocked even based on a relatively low volume of detected sent messages that include a link to the phishing site.

### Illustrative Environment

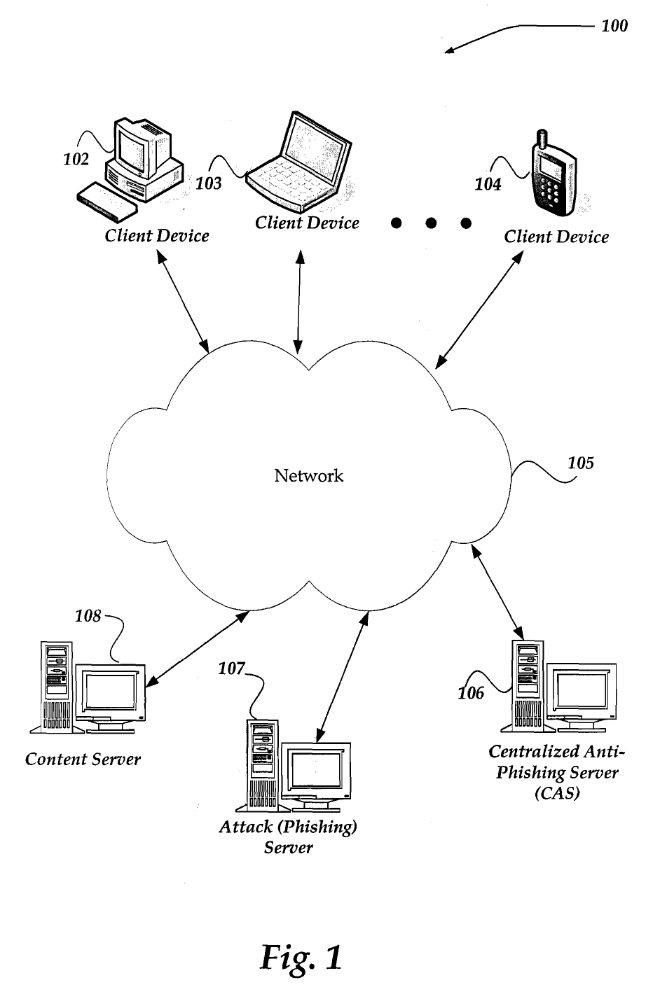

FIG. 1 is a functional block diagram illustrating an exemplary operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes client devices 102-104, network 105, content server 108, centralized anti-phishing server (CAS) 106, and attack (phishing) server 107. Client devices 102-104 are in communication with each other, CAS 106, content server 108, and attack server 107 through network 105. CAS 106, content server 108, and attack server 107 may also be in communication with each other through network 105.

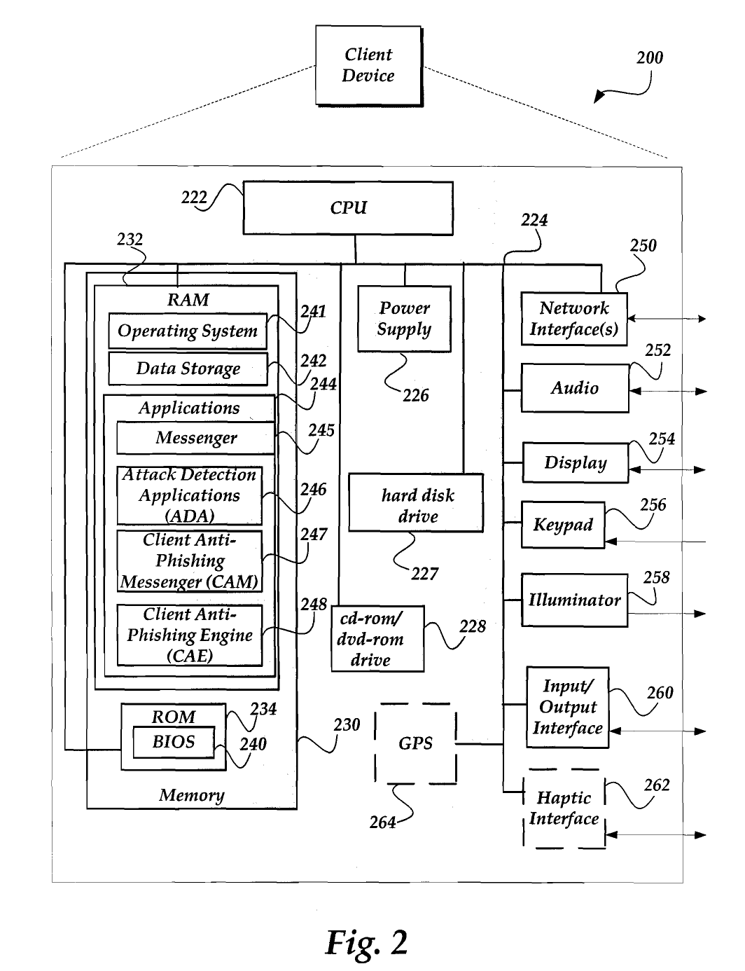

One embodiment of a client device is described in more detail below in conjunction with FIG. 2. Briefly, however, client devices 102-104 may include virtually any computing device capable of receiving and sending a message over a network, such as network 105, to and from another computing device. The set of such devices described in an exemplary embodiment below generally includes mobile devices that are usually considered more specialized devices with limited capabilities and typically connect using a wireless communications medium such as cell phones, smart phones, pagers, radio frequency (RF) devices, infrared (IR) devices, CBs, integrated devices combining one or more of the preceding devices, or virtually any mobile device, and the like. However, the set of such devices may also include devices that are usually considered more general purpose devices and typically connect using a wired communications medium at one or more fixed location such as laptop computers, personal computers, multiprocessor systems, microprocessor-based or programmable consumer electronics, network PCs, and the like. Similarly, client devices 102-104 may be any device that is capable of connecting using a wired or wireless communication medium such as a personal digital assistant (PDA), POCKET PC, wearable computer, and any other device that is equipped to communicate over a wired and/or wireless communication medium.

Each client device within client devices 102-104 may include an application that enables a user to perform various operations. For example, each client device may include one or more messenger applications that enables the client device to send and receive messages to/from another computing device employing various communication mechanisms, including, but not limited to Short Message Service (SMS), Multimedia Messaging Service (MMS), Instant Messaging (IM), internet relay chat (IRC), Mardam-Bey's internet relay chat (mIRC), Jabber, email, and the like.

Client devices 102-104 may be further configured with a browser application that is configured to receive and to send content in a variety of forms, including, but not limited to markup pages, web-based messages, audio files, graphical files, file downloads, applets, scripts, text, and the like. The browser application may be configured to receive and display graphics, text, multimedia, and the like, employing virtually any markup based language, including, but not limited to a Handheld Device Markup Language (HDML), such as Wireless Markup Language (WML), WMLScript, JavaScript, and the like, Standard Generalized Markup Language (SGML), HyperText Markup Language (HTML), Extensible Markup Language (XML).

Client devices 102-104 may be further configured to include a client based anti-phishing engine (CAE). One embodiment, of a CAE is described in more detail below in conjunction with FIG. 2. Briefly, however, the CAE may operate as a downloadable application, script, applet, or the like, that is configured to collect various information about potential and/or known phishing sites. The CAE operate in conjunction with a messenger application on the client devices, to intercept an IM message, or the like, to determine whether the message may include a phishing site. If the message is determined to include a suspected phishing site, the CAE may instruct an anti-phishing messenger (CAM) component within client devices 102-104 to block the message, and/or provide a warning to a user.

Client devices 102-104 may also include a variety of applications, scripts, applets, or the like, configured to detect and/or block known SPAM, SPIM, and/or phishing sites. Such applications may includes, operating system components, browsers, plug-ins to browsers, personal firewall applications, anti-virus applications, email analysis tools, or the like. Such applications, and the like, typically may receive update information indicating that a site has been identified as a known site to be blocked. Traditionally, such update information is provided based on the user downloading the update or the application automatically downloading the update. Moreover, such update information has typically been based on known detections over a long period of time, and/or after a significant large number of occurrences of the site have been reported.

Network 105 is configured to couple client devices 102-104, with other network devices. Network 105 is enabled to employ any form of computer readable media for communicating information from one electronic device to another. In one embodiment, network 105 is the Internet, and may include local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 105 may further employ a plurality of wireless access technologies including, but not limited to, 2nd (2G), 3rd (3G) generation radio access for cellular systems, Wireless-LAN, Wireless Router (WR) mesh, and the like. Access technologies such as 2G, 3G, and future access networks may enable wide area coverage for network devices, such as client device 102, and the like, with various degrees of mobility. For example, network 105 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like.

Furthermore, remote computers and other related electronic devices could be remotely connected to either LANs or WANs via a modem and temporary telephone link. In essence, network 105 includes any communication method by which information may travel between client devices 102-104, APS 106, and/or attack server 107.

Additionally, network 105 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

Attack (phishing) server 107 includes virtually any network computing device that is configured to provide various resources, including content and/or services over network 105. However, in FIG. 1, attack server 107 represents a server that may also be configured to provide misleading, and/or fraudulent information. Thus, in one embodiment, attack server 108 represents at least a suspected phishing site.

For example, attack server 107 may provide at least some phishing content and/or services for any of a variety of activities that may appear legitimate, including, but not limited to merchant businesses, financial businesses, insurance businesses, educational, governmental, medical, communication products, and/or services, or virtually any other site of interest.

Typically, attack server 107 may include an interface that may request sensitive information from a user of client device 102-104. For example, attack server 107 may provide access to what appears to be a legitimate account, which may request user log-in information. Such log-in information may include a user name, password, an entry of a key number, or the like. In another example, attack server 107 may request other sensitive information, such as a credit card number, medical information, or the like. For example, attack server 107 may operate as a merchant site that on at least one webpage of its website, there is a request for entry of sensitive information, including financial information, or the like. In one embodiment, a webpage may include a form or virtually any other data entry mechanism.

In one embodiment, network links to attack server 107 may be provided to client devices 102-104 by way of various communication mechanisms, including, but not limited to email, SMS messages, IM messages, within a webpage hosted by content server 108, another server (not illustrated), or even by another client device. Thus, attack server 107 may also be configured and arranged such that the messages send to client devices 102-104 that may include a link to a webpage hosted on attack server 107, may be sent by another device, other than attack server 107. For example, in one embodiment, the message might be sent by one of client devices 102-104.

Devices that may operate as attack server 107 include, but are not limited to personal computers, desktop computers, multiprocessor systems, microprocessor-based or programmable consumer electronics, network PCs, servers, network appliances, and the like.

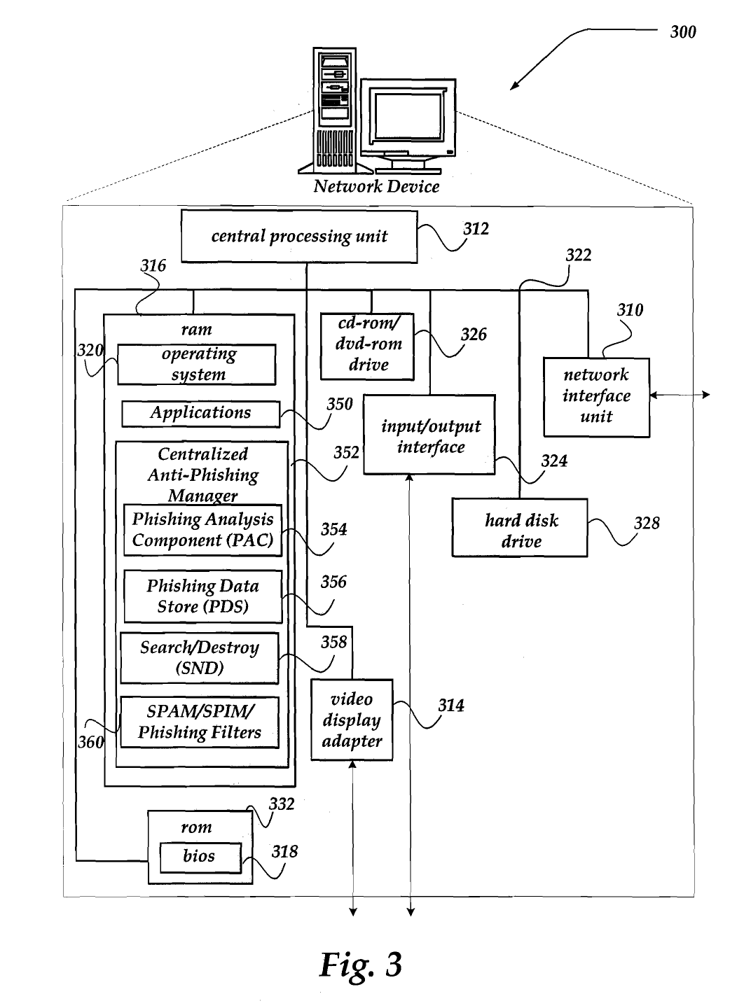

One embodiment of CAS 106 is described in more detail below in conjunction with FIG. 3. Briefly, however, CAS 106 includes virtually any network device that is configured to enable collect phishing information from a plurality of client devices, such as client devices 102-104, analyze the collected information, and to perform a “search and destroy” action to locate a source of the phishing link, and to attempt to prevent future occurrences of phishing activities from the located source. In one embodiment, CAS 106 may further update a phishing filter that is arranged to detect and block phishing links before a client device receives a message including the link. CAS 106 may employ a volume sensitive mechanism to determine whether to block the message/link, where the volume may be set to a relatively low value, such as between 2-5 identified instances, or the like. While the invention is not limited to these values, a relatively low value enables a rapid response to potentially fraudulent behavior. In one embodiment, however, the volume value may be configured such that a value of between about 2-5 might result in providing information to client devices 102-105 that might generate a warning message for users, absent blocking the message. When the volume exceeds the defined volume value, CAS 106 might then initiate active blocking of messages and/or links associated with the phishing site.

Devices that may operate as CAS 106 include, but are not limited to personal computers, desktop computers, multiprocessor systems, microprocessor-based or programmable consumer electronics, network PCs, servers, network appliances, and the like.

Content server 108 may include virtually any network device configured to provide to information about known phishing sites to client devices 102-104. Such information typically may be based on a large volume of reported phishing instances for a given site, and usually obtained over a period of time. Content server 108 may provide such information in a period batch delivery to client devices 102-104. Content server 108 may obtain the information about known phishing sites from a variety of other sources, including but not limited to open source origins, such as Phish Tank, third party paid sources, or the like. Content server 108 may provide the information using a variety of mechanisms. For example, in one embodiment, content server 108 may condense the information based on bloom filter, or the like. However, other data structures may also be employed. Devices that may operate as content server 108 include, but are not limited to personal computers, desktop computers, multiprocessor systems, microprocessor-based or programmable consumer electronics, network PCs, servers, network appliances, and the like.

It should be noted that while content server 108 and CAS 106 are each illustrated as single distinct network devices, the invention is not so limited. For example, CAS 106 may comprise a plurality of network devices, with various functions distributed across the plurality. Such plurality may be arranged to operate as peer to peer configurations, cluster configurations, distinct devices, or the like. Similarly, content server 108 may represent a plurality of network devices each being configured to obtain known phishing site information and provide it to client devices 102-104 based, in part, on a time period.

Moreover, while a single attack server 107 is illustrated, it is apparent that many more attack servers may communicate over network 105. Thus, attack server 107 is intended to merely represent one example of a suspect phishing site. It should be clear that not all of the network devices that communicate over network 105 are phishing sites, and while not illustrated, many legitimate services and/or products may be provided to client devices 102-104 over network 105.

### Illustrative Client Device

FIG. 2 shows one embodiment of client device 200 that may be included in a system implementing the invention. Client device 200 may represent one embodiment of client devices 102-104 of FIG. 1. Client device 200 may include many more or less components than those shown in FIG. 2. However, the components shown are sufficient to disclose an illustrative embodiment for practicing the present invention.

As shown in the figure, client device 200 includes a processing unit 222 in communication with a mass memory 230 via a bus 224. Client device 200 also includes a power supply 226, one or more network interfaces 250, an audio interface 252, a display 254, a keypad 256, an illuminator 258, an input/output interface 260, optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, and the like.

Audio interface 252 is arranged to produce and receive audio signals such as the sound of a human voice, music, or the like. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Client device 200 may further include additional mass storage facilities such as CD-ROM/DVD-ROM drive 228 and hard disk drive 227. Hard disk drive 227 is utilized by client device 200 to store, among other things, application programs, databases, and the like. Additionally, CD-ROM/DVD-ROM drive 228 and hard disk drive 227 may store cookies, data, images, or the like.

Keypad 256 may comprise any input device arranged to receive input from a user (e.g. a sender). For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, and the like. Optional haptic interface 262 is arranged to provide tactile feedback to a user (e.g. a sender) of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS and the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include an interface with a Java virtual machine module that enables control of hardware components and/or operating system operations via Java application programs.

Client device 200 may also be configured to manage activities and data for one user distinct from activities and data for another user of client device 200. For example, in one embodiment, operating system 241 may be configured to manage multiple user accounts. For example, client device 200 may employ an operating system that is configured to request a user to provide account information, such as a user name/password, smart card, s/key, or the like. When the user logs into the associated account, operating system 241 may then manage data, activities, and the like, for the user separate from at least some of the data, activities, and the like, for another user. Thus, in one embodiment, operating system 241 may be configured to store client device data, cookies, anti-phishing data, or the like, based on a client device account. Moreover, settings, configurations, or the like, attack detection application (ADA) 246, messenger 245, or the like, may be based on the user account. Thus, when user A is logged into their client user account, browser (not illustrated) may receive, store, and/or retrieve cookies for user A, distinct from cookies associated with another user account on client device 200.

Memory 230 further includes one or more data storage 242, which can be utilized by client device 200 to store, among other things, applications 244 and/or other data. For example, data storage 242 may also be employed to store information that describes various capabilities of client device 200. The information may then be provided to another device based on any of a variety of events, including being sent as part of a header during a communication, sent upon request, and the like. Moreover data storage 242 may be used to store information such as data received over a network from another computing device, data output by a client application on client device 200, data input by a user of client device 200, or the like. For example, data storage 242 may include data, including cookies, and/or other client device data sent by a network device. Data storage 242 may also include image files, anti-phishing data, or the like, for display and/or use through various applications. Moreover, although data storage 242 is illustrated within memory 230, data storage 242 may also reside within other storage mediums, including, but not limited to CD-ROM/DVD-ROM drive 228, hard disk drive 227, or the like.

Applications 244 may also include computer executable instructions which, when executed by client device 200, transmit, receive, and/or otherwise process messages and enable telecommunication with another user of another client device. Other examples of application programs include calendars, contact managers, task managers, transcoders, database programs, word processing programs, spreadsheet programs, browsers, games, CODEC programs, and so forth. In addition, applications 244 may include messenger 245, Attack Detection Applications (ADA) 246, client anti-phishing messenger (CAM) 247, and client anti-phishing engine (CAE) 248. It should be noted, that while CAM 247 and CAW 248 are illustrated as separate applications, the invention is not so limited. For example, one may be a component of the other application.

ADA 246 includes any of a variety of applications, operating system components, or the like, that are configured to monitor for SPIM, SPAM, viruses, malware, network links to known phishing sites, or the like. As such, ADA 246 may include anti-virus applications, browser plugin malware detectors, local firewall applications, or the like. In one embodiment, ADA 246 may receive updates to a data store, internal engine, or the like, providing information about recently detected programs, links, or the like. ADA 246 may also provide a message, such as a warning, alert, or the like, when unauthorized known activity is detected, a known phishing site is detected, or the like. In one embodiment, the message, or the like, may be detected by CAE 248.

Messenger 245 may be configured to initiate and manage a text messaging session using any of a variety of text messaging communications including, but not limited to email, Short Message Service (SMS), Instant Message (IM), Multimedia Message Service (MMS), internet relay chat (IRC), mIRC, and the like. For example, in one embodiment, messenger 245 may be configured as an IM application, such as AOL Instant Messenger, Yahoo! Messenger, .NET Messenger Server, ICQ, or the like. In another embodiment, messenger 245 may be a client application that is configured to integrate and employ a variety of text messaging protocols.

Moreover, messenger 245 may be configured to receive a request for or a link to a request for sensitive user information, such as username/password, credit card information, medical information, or the like. For example, in one embodiment, messenger 245 may receive a message that includes a link to a webpage, or the like, that may request sensitive user information. Thus, in one embodiment, messenger 245 may interact with CAE 248. For example, in one embodiment, text messages directed to client device 200 might initially be directed towards CA 248, prior to being received by messenger 245. In another embodiment, messenger 245 may redirect received messages to CAE 248 for examination prior to displaying them within messenger 245.

CAE 248 is configured and arranged to collect phishing data from a variety of sources, including, but not limited to ADA 246, operating system 241, user inputs, inputs from external content server sites, such as content server 108 and CAS 106 of FIG. 1, or the like. CAE 248 may receive at least some of the phishing data in a condensed format, such as might be useable with a bloom filter, or the like. However, the invention is not so limited, and the data may be received, and/or managed using any of a variety of other data structures, without departing from the scope of the invention. Moreover, in one embodiment, CAE 248 may select to store at least some of the collected phishing data in data storage 242, within hard disk drive 227, or the like.

CAE 248 may, in one embodiment, intercept, or otherwise, receive a text message to be examined. In one embodiment, CAE 248 may employ the collected phishing data to determine whether the received text message includes a known phishing site link, or a suspected phishing site link. In one embodiment, such weighting of a network site may be performed by CAE 248; however, in another embodiment, the weighting of network sites may be performed by a remote device and provided as part of the information collected by CAE 248.

In any event, in one embodiment, a suspected phishing site link might be identified based on a minimum number of detections, either by client device 200, and/or by other client devices. For example, in one embodiment, a link to a network site might be identified as a suspected phishing site where more than one but less than say 3-5 client devices have identified the site as a phishing site. It should be clear, however, that other values may be used, and the invention is not limited to these values. When a site is identified as a suspected phishing site, CAE 248 may communicate with CAM 247 to have a warning message displayed, or similar message be provided to a user of client device 200. In one embodiment, CAE 248 may allow the message to include the link to the suspected phishing site, and further enable the user to select to access the site. Thus, briefly, CAM 247 is configured to provide warning messages, blocking messages, or the like, to the user.

In one embodiment, CAE 248 may collect additional information about the message, including, a network address associated with the message, a time when the message is received/sent, or the like, a physical location of client device 200, or virtually any other information that might be useable to locate a source of the message, and/or phishing site.

Where the link is determined by CAE 248 to be from a known phishing site, based on the collected information, CAE 248 may select to expunge the text message of the link, delete the text message, provide a message to the user indicating that a message was received to a known phishing site, or the like. In one embodiment, CAE 248 may determine that the site is a known phishing site based a number of client devices reporting the site as a phishing site. For example, CAE 248 may determine the site is a phishing site when the number of reporting client devices exceeds five. In one embodiment, to ensure that such reportings are valid, CAE 248 might look to network addresses of the client devices to determine whether the client device reportings are from five or more different client devices. Again, it should be noted that five is not a required number, and virtually any other number may be used, without departing from the scope of the invention.

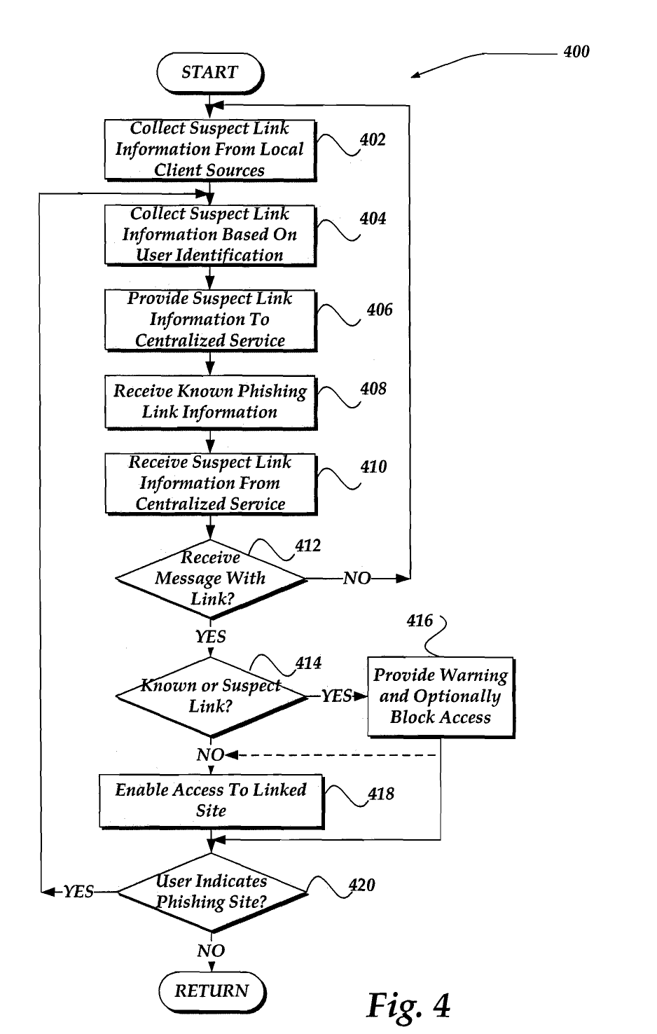

As noted above, a user may also provide input regarding a link within a text message. Such user information is also collected by CAE 248, as well as any related phishing data, including, but not limited to, source network address, time, number of times the link is received, whether the link is received from different sources, or the like. In any event, data collected by CAE 248 based on internal actions, such as from operating system 241, ADA 246, and/or user inputs, or the like, may be provided to a remote network device, such as CAS 106, or the like. By providing client device data to a centralized server, other client devices may more rapidly share and detect phishing sites. CAE 248 may employ a process substantially similar to process 400 of FIG. 4 described below, to perform at least some of its actions.

### Illustrative Server Environment

FIG. 3 shows one embodiment of a network device, according to one embodiment of the invention. Network device 300 may include many more or less components than those shown. For example, network device 300 may operate as a network appliance without a display screen. The components shown, however, are sufficient to disclose an illustrative embodiment for practicing the invention. Network device 300 may, for example, represent CAS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, network interface card (NIC), or the like.

Network device 300 may also include an SMTP handler application for transmitting and receiving email. Network device 300 may also include an HTTP handler application for receiving and handing HTTP requests, and an HTTPS handler application for handling secure connections. The HTTPS handler application may initiate communication with an external application in a secure fashion.

Network device 300 also may include input/output interface 324 for communicating with external devices, such as a mouse, keyboard, scanner, or other input devices not shown in FIG. 3. Likewise, network device 300 may further include additional mass storage facilities such as CD-ROM/DVD-ROM drive 326 and hard disk drive 328. Hard disk drive 328 is utilized by network device 300 to store, among other things, application programs, databases, or the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs include email programs, schedulers, calendars, transcoders, database programs, word processing programs, spreadsheet programs, security programs, web servers, and so forth. Mass storage may further include Centralized Anti-Phishing Manager 352 that is arranged and configured to provide a centralized management of messaging related phishing information. Centralized Anti-Phishing Manager 3 52 is directed towards receiving phishing information from a plurality of different client devices. Centralized Anti-Phishing Manager 352 may then employ the information to search for a source of the phishing information, such as a phishing site, owner, messenger, or the like, and seek to inhibit future phishing attempts. Centralized Anti-Phishing Manager 352 may employ various filters to inhibit phishing attempts by identified sources, as well as share information with other services, agencies, and the like, to further inhibit future phishing attempts by the identified source.

Centralized Anti-Phishing Manager 352 includes several components, including Phishing Analysis Component (PAC) 354, Phishing Data Store (PDS) 356, Search/Destroy (SND) 358, and SPAM/SPIM/Phishing filters (filters) 360. Although not shown, Centralized Anti-Phishing Manager 352 may also include Application Programming Interfaces (APIs), scripts, applets, programs, or the like, that are configured to enable a variety of other services, agencies, and the like to access and share phishing information.

PDS 356 includes virtually any mechanism arranged to receive, store, and manage, phishing information. Such phishing information includes, but is not limited to links to network sites, network addresses, text messages associated with phishing links, times associated with when a phishing link is detected, a number of times the links are detected, geographic information associated with where such messages with the phishing links were received, client device information related to identifying a link as a phishing link, and any other information useable for identifying a phishing site, source of related messages to the site, or the like. PDS 356 may be implemented as a database, spreadsheet, folder, program, or the like.

PAC 354 is configured to receive phishing information from a plurality of client devices and to perform analysis on the received information, including determining where the phishing service is located (including a physical address, a network address, an owner, or the like); how many different client devices have reported the link; determining whether the same or similar link appears in different groups of network addresses, geographic regions, or the like; determining whether the link appears in other communication mechanisms, such as email, within a website, or the like. PAC 354 may, in one embodiment, based on the collected information classify a link as a suspected phishing site, a known phishing site, or even as an un-known status site. PAC 354 may perform such classification by providing a weighting to each site, based on a number of reportings for the link. For example, where one client device has reported a site, PAC 354 might provide a weighting of one, while if two different client devices reported the site, PAC 3 54 might provide a weighting of two, and so forth. Thus, the weighting may be used as a confidence level indicating a likelihood that a site is a known phishing site, a suspect phishing site, or the like. Similarly, if a site is initially identified as a suspect phishing site by a small number of different client devices during one period of time, and no additional reportings occur after that period, the site might be receive a lower weighting—based on a function of time. Thus, weighting may be a function of a variety of different factors, including, but not limited to number of different client device reportings, a period of time, a geographic region, or the like. In any event, PAC 354 may then provide to client devices such weighting information, as well as other information collected and/or analyzed from the plurality of client devices.

SND 358 may employ at least some of the analyzed data from PAC 354 to seek to locate a location hosting the phishing site. It one embodiment, SND 358 may employ various tools, including WHOIS, or the like, to determine an owner, provider, host, and/or physical location of the phishing site. SND 358 may then attempt to determine if the known phishing site can be ‘stopped,’ or otherwise prevented from additional phishing activities. In one embodiment, SND 358 might notify a domain host provider, or the like, of such improper activities by the phishing site owner. In one embodiment, SND 358 might provide similar information to an agency, law enforcement authority, or the like.

SPAM/SPIM/Phishing Filters (filters) 360 includes one or more filters, blocking programs, or the like, that may be configured to block, messages that include a link to a known phishing site, expunge a message of a link to a known phishing site, or the like. In one embodiment, filters 360 may be configured to perform such actions even where a relatively low volume of reportings are received for a site from different client devices, where low may be based on any of the above discussions, including but not limited to a value of between 2-5.

### Generalized Operation

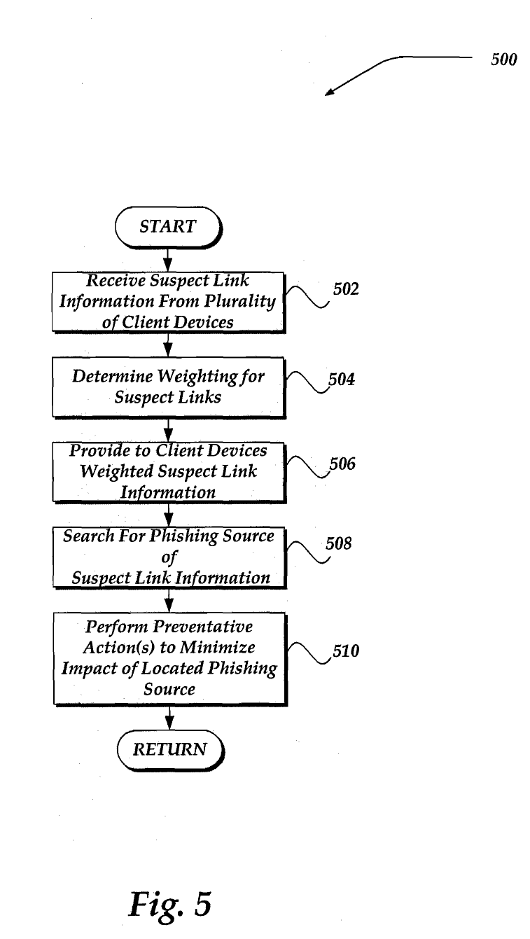

The operation of certain aspects of the invention will now be described with respect to FIGS. 4-5. FIG. 4 illustrates a flow diagram generally showing one embodiment for a client process of managing a client side detection of an instant messaging (IM) phishing attempt. Process 400 of FIG. 1 may, for example, be implemented within at least one of client devices 102-104 of FIG. 1.

Process 400 of FIG. 4 begins, after a start block, at block 402 where the client device is arranged to collect suspect link information from local client sources. Such local client sources include, but are not limited to operating system components, anti-virus applications, browser components, client firewall components, or the like. While such components may provide notice indicating that a particular link is being blocked, other, related information may also be collected, including, but not limited to a time of detection (or blocking), a source of a message associated with the link, a network address of the link, information about whether the link is associated with a received email message, a received text message, or is located within a webpage, or the like.

Processing then proceeds to block 404, where information about a link may also be obtained based on a user input. For example, a user may select the link from within a webpage, a message, or the like, and determine that the link is to a webpage that is suspect. Such determination may be made based on a variety of factors available to the user, including, but not limited, to a misspelling within the webpage, improper grammar, suspect graphics, questions, or the like. In any event, in one embodiment, an icon, button, or the like, may be available to the user within a browser, messaging application, or the like. The user may select the icon, button, or the like, to indicate that the link is suspect. Various data may then be collected, including the data mentioned above, such as time, source of link, link information, or the like.

Processing continues to block 406, where suspect link information collected during blocks 402 and 404 may be provided to a centralized service, such as CAS 106 of FIG. 1, or the like. Processing continues next to block 408, where known phishing link information may be received. Such known phishing link information may be received from a variety of sources, including, a content server 108 of FIG. 1, or the like. In one embodiment, such information is received in a data structure useable by a bloom filtering process, or the like.

Process 400 flows next to block 410, where additional phishing link information may be received from the centralized service. Such phishing link information represents information obtained through a plurality of client devices, and in one embodiment, includes a weighting factor indicating, for example, whether the link is to a suspect site, a known phishing site, or the like.

Processing flows next to decision block 412, where a determination is made whether a text message is received that includes a link to a webpage. If so, processing flows to decision block 414; otherwise, processing loops back to block 402 to continue to collect phishing data.

At decision block 414, the collected phishing information is employed to determine whether the link is to a suspected or known phishing site. As noted above, a suspected or known phishing site may be based on a weighting, such as between 2 to 5, above 5, or a similarly defined value. In any event, if the link is determined to be to a suspected or known phishing site, processing branches to block 416; otherwise processing flows to block 418.

At block 416, in one embodiment, if the link is to a suspected phishing site, based on a low weighting, such as between 2 to 5, or so, then a warning message might be provided to the user of the client device. However, in one embodiment, the message including the link may be provided to the user. In another embodiment, the message and/or the link may be blocked from access by the user. Processing may then flow to decision block 420, where the message/link is blocked, or to block 418, where the message/link is not blocked from access by the user.

At block 418, the user may be enabled to access the received message and/or link. In one embodiment, the link may be available and may be selected by the user. If the user selects the link, the client device may bring up a browser, or other application, that enables the user to view the contents of a webpage associated with the link. Processing then flows to decision block 420, where the user may, based on any of a variety of factors, determine that the link is to a suspected phishing site. If the user so indicates that the link is to a suspected phishing site, processing loops back to block 404, where data related with the identified site are collected. Otherwise, processing may return to a calling process to perform other actions.

FIG. 5 illustrates a flow diagram generally showing one embodiment for a centralized server process of providing text messaging phishing detection, identification, and prevention, in accordance with the invention. In one embodiment, process 500 of FIG. 1 may be implemented with CAS 106 of FIG. 1.

Process 500 begins, after a start block, at block 502, where a centralized anti-phishing service receives suspect link information from a plurality of client devices. Such information may include, but is not limited to the suspect link, a source of the link, a time/date for when the link is received/detected, client device information, including a network address, or the like, or virtually any other information useable to locate a source of the phishing link.

Processing continues next to block 504, where a weighting is determined for the suspect links. As noted above, the weighting may be based on a number of client devices reporting the link as suspect, a location of the reports, a time of the reports, whether there is a lapse of time between reportings of the link, or the like. Processing then continues to block 506, where the weighted link information may be provided to the plurality of client devices, to share the phishing information between client devices.

Process 500 continues next to block 508, where, based, in part, on the weighted link information, a source of the link, such as an owner of the link, a domain registrar, or the like, is determined. In one embodiment, the search may be performed for those links determined, based on the weighting, to be a known phishing site (e.g., greater than five different client device reportings, or the like).

Processing flows next to block 510, where preventative actions may then be performed to minimize impact of additional phishing activities based on finding a source of the known phishing site. Such preventative actions may include removing the webpage from a host server, sending messages to a law enforcement agency, domain registrar, domain name dispute resolution agency, or the like. In any event, processing may then return to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause operational steps to be performed by the processor to produce a computer implemented process such that the instructions, which execute on the processor to provide steps for implementing the actions specified in the flowchart block or blocks. In one embodiment, at least some of the operational steps may be performed serially; however, the invention is not so limited, and at least some steps may be performed concurrently.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A client device for detecting phishing over a network, comprising:
a transceiver for receiving and sending information over the network;
a processor in communication with the display and the transceiver; and
a memory in communication with the processor and for use in storing data and machine instructions that causes the processor to perform a plurality of actions, including:
receiving weighted phishing data collected from a plurality of other client devices;
receiving a text message having a link to a webpage;
employing the weighted phishing data to determine whether the link is suspected or known as a phishing link;
if the link is determined to be a suspected phishing link, displaying a warning message to a user of the client device indicating that the link is suspect; and
if the link is determined to be a known phishing link, blocking access to the link by the user.

2. The client device of claim 1, wherein the plurality of actions further comprising:
collecting phishing data from at least one application or operating system component within the client device; and
sending the collected phishing data to a centralized anti-phishing service, wherein the centralized anti-phishing service is configured to perform actions, including:
receiving phishing data from the plurality of other client devices;
weighting the received phishing data from the client device and the plurality of other client devices based in part on a number of other client devices providing phishing data associated with a similar link; and
sending the weighted phishing data to the client device.

3. The client device of claim 2, wherein the centralized anti-phishing service performs actions, further comprising:
determining if the weighted phishing data indicates a link to be to a known phishing site based on a number of different client devices reporting the link exceeding a defined number; and
if the link is determined to be to a known phishing site, employing the received phishing data to locate a source of the phishing site.

4. The client device of claim 2, wherein the centralized anti-phishing service is configured to perform actions, further comprising: employing the received phishing data to locate a source of a known phishing site and to perform actions directed to inhibiting additional phishing activity from the phishing site.

5. The client device of claim 1, wherein determining whether the link is suspect or known further comprises:
if a number of different client devices reporting the link is below a defined number, but greater than zero, indicating the link to be a suspected phishing link; and
if the number of different client devices reporting the link is at or above the defined number, indicating the link to be a known phishing link.

6. A processor readable storage medium having computer-executable instructions, wherein the execution of the computer-executable instructions provides for managing a phishing attack by enabling actions, including:
receiving from a plurality of client devices, phishing data associated with a possible phishing site;
weighting the received phishing data based, in part, on a number of different client devices reporting the possible phishing site, wherein the weighting is arranged to classify the possible phishing site into one of a suspected phishing site or a known phishing site; and
providing the weighting to at least one client device within the plurality of client devices, wherein the at least one client device is configured to perform actions, including employing the weighted phishing data to determine whether to display a warning message or block access to the phishing site identified by a link within a received text message.

7. The processor readable storage medium of claim 6, wherein the phishing data further comprises at least one of a network address to the phishing site, a time when each reporting client device detected the phishing site, a network address of each reporting client device, a client application identifier associated with detecting the phishing site, a geographic location of the client device reporting the detected phishing site, a frequency of times the reporting client device detected the phishing site, or a communication mechanism in which a link to the phishing site was received by the reporting client device.

8. The processor readable storage medium of claim 6, wherein the computer-executable instructions enable actions, further comprising:
if the phishing site is determined to be a known phishing site, performing actions, including:
modifying a blocking filter to block text messages to the plurality of client devices that include a link to the known phishing site;
employing the received phishing data to identify at least one of a domain registrar or host server associated with the known phishing site; and
performing at least one action directed to inhibiting a future phishing activity to be performed by the known phishing site.

9. The processor readable storage medium of claim 6, wherein classifying the possible phishing site as a suspected phishing site further comprises classifying the site based on a small population size of different client devices.

10. The processor readable storage medium of claim 6, wherein classifying the phishing data is performed based on a number of different client devices reporting the phishing site being

11. The processor readable storage medium of claim 6, wherein the computer-executable instructions enable actions, further comprising:
providing the received phishing data from the plurality of client devices to at least one other service configured to perform blocking of phishing sites.

12. A network device for detecting a phishing attack, comprising:
a transceiver to send and receive data over a network; and
a processor that is operative to perform actions, including:
receiving from a plurality of client devices, phishing data associated with a possible phishing site, wherein the received phishing data is based on at least one of a user detected phishing site or detection based on a client application or client operating system;
classifying the possible phishing site based, in part, on a defined relatively small number of different client devices reporting the possible phishing site, wherein the possible phishing site is classified as one of a suspected phishing site or a known phishing site;
providing the classification to at least one client device within the plurality of client devices, for use in determining whether to display a warning message or block access to the phishing site identified by a link within a client received text message; and
if the phishing site is classified as a known phishing site, performing at least one action directed to inhibiting a future phishing activity from the known phishing site.

13. The network device of claim 12, wherein the defined relatively small number of different client devices is a number less than about twenty-five.

14. The network device of claim 12, wherein the phishing data further comprises at least one of a network address to the phishing site, a time when each reporting client device detected the phishing site, a network address of each reporting client device, a client application identifier associated with detecting the phishing site, a geographic location of the client device reporting the detected phishing site, a frequency of times the reporting client device detected the phishing site, or a communication mechanism in which a link to the phishing site was received by the reporting client device.

15. The network device of claim 12, wherein the processor is operative to perform actions, further including:
if the possible phishing site is classified as a known phishing site, employing a filter to block or modify a text message that includes a link to the known phishing site.

16. The network device of claim 12, wherein at least one client device is configured to receive additional phishing information from at least one other source, including, a third party content data source.

17. A method of managing a phishing attack over a network, comprising:
receiving, from a plurality of client devices, phishing data associated with a plurality of possible phishing sites, wherein the received phishing data is based on at least one of a user detected phishing site or detection based on a client application or client operating system;
classifying the phishing sites based, in part, on a defined number of different client devices reporting the possible phishing sites, wherein the possible phishing sites are classified as one of a suspected phishing site or a known phishing site;
providing the classifications to at least one client device within the plurality of client devices, for use in determining a response to a text message received by the at least one client device having a link to a webpage; and
if a possible phishing site is classified as a known phishing site, performing at least one action directed to inhibiting a future phishing activity from the known phishing site.

18. The method of claim 17, wherein the at least one client device is configured to receive phishing data from at least one other non-client device source.

19. The method of claim 17, wherein phishing data includes information identifying a source of the phishing sites, a network address for the reporting client device, or a time of the detection.

20. A modulated data signal configured to include program instructions for performing the method of claim 17.
